(19) United States
(12) Patent Application Publication
(10) Pub. No.: US 2025/0333163 A1
(43) Pub. Date: Oct. 30, 2025

(54) INFORMATION PROCESSING DEVICE, DISPLAY CONTROL METHOD, AND NON-TRANSITORY COMPUTER READABLE MEMORY

(71) Applicant: Rakuten Group, Inc., Tokyo (JP)

(72) Inventor: Asaki MATSUMOTO, Tokyo (JP)

(73) Assignee: Rakuten Group, Inc., Tokyo (JP)

(21) Appl. No.: 19/186,012

(22) Filed: Apr. 22, 2025

(30) Foreign Application Priority Data
Apr. 26, 2024 (JP) 2024-072709

(51) Int. Cl. B64C 39/02

(52) U.S. Cl. CPC B64C 39/024

(57) ABSTRACT

The management server causes the operator terminal to display the drone lists including the drone simple information on each of the plurality of the drones that requires monitoring by the operator, and identifies the drone status of each of the plurality of the drones. Then, the management server identifies, based on the identified drone statuses, the monitoring priority of each drone, and controls the display of the drone list according to the identified monitoring priorities.

### CROSS REFERENCE TO RELATED APPLICATION

This application claims priority from Japanese Patent Application No. 2024-072709 which was filed on Apr. 26, 2024, the disclosure of which is herein incorporated by reference in its entirety.

### TECHNICAL FIELD

One or more embodiments of the present invention relate to a technical field of a system in which an operator can remotely monitor a plurality of unmanned aerial vehicles.

### RELATED ART

Conventionally, a system in which an operator can monitor and operate the plurality of unmanned aerial vehicles is known. For example, JP 2022-529507 A discloses a system in which at least one operator can monitor each UAV using a computing device capable of communicating with each of a plurality of UAVs (Unmanned Aerial Vehicles) and operate the take-off, ascent, descent, landing, etc. of the UAV. In JP 2022-529507 A, it is described that an example in which 10 operators monitor 500 UAVs.

However, for example, when a single operator monitors multiple unmanned aerial vehicles remotely, the operator's monitoring burden would increase. As a result, it may take time for the operator to grasp the unmanned aerial vehicle that requires prioritized monitoring, such as during take-off or landing, and the operator's response may be delayed.

Therefore, one or more embodiments of the present invention are to providing an information processing device, a display control method, and a non-transitory computer readable memory that enable the operator, who remotely monitors the plurality of unmanned aerial vehicles, to quickly grasp an unmanned aerial vehicle that requires prioritized monitoring.

### SUMMARY

(An aspect 1) In response to the above issue, an information processing device includes: at least one memory configured to store program code; and at least one processor configured to access the program code and operate as instructed by the program code. The program code includes: first display control code configured to cause the at least one processor to display, on a terminal of an operator, a first list including information on each of a plurality of unmanned aerial vehicles that require monitoring by the operator; first identification code configured to cause the at least one processor to identify a status of each of the plurality of the unmanned aerial vehicles; and second display control code configured to cause the at least one processor to control, based on the status of each of the plurality of the unmanned aerial vehicles, the display of the first list.

(An aspect 2) A display control method executed by one or more computers, includes: displaying, on a terminal of an operator, a first list including information on each of a plurality of unmanned aerial vehicles that require monitoring by the operator; identifying a status of each of the plurality of the unmanned aerial vehicles; and controlling the display of the first list based on the status of each of the plurality of the unmanned aerial vehicles.

(An aspect 3) A non-transitory computer readable memory has stored thereon a program configured to cause a computer to: display, on a terminal of an operator, a first list including information on each of a plurality of unmanned aerial vehicles that require monitoring by the operator; acquire a status of each of the plurality of the unmanned aerial vehicles from a predetermined server; and control the display of the first list based on the status of each of the plurality of the unmanned aerial vehicles.

### BRIEF DESCRIPTION OF THE DRAWINGS

FIG. 1 is a diagram illustrating a schematic configuration example of a remote monitoring system S.

FIG. 2 is a diagram illustrating a schematic configuration example of a drone Dn.

FIG. 3 is a diagram illustrating a schematic configuration example of an operator terminal Tm.

FIG. 4 is a diagram illustrating a display example of a drone monitoring screen displayed on the operator terminal T1 of an operator OP1.

FIG. 5 is a diagram illustrating a schematic configuration example of a management server MS.

FIG. 6 is a diagram illustrating an example of a monitoring priority master table.

FIG. 7 is a diagram illustrating an example of functional blocks in a control unit 33.

FIG. 8 is a diagram illustrating a display example of a drone monitoring screen displayed on the operator terminal T1 when a drone D1 with a lower monitoring priority than a drone D3, is first selected by the operator OP1.

FIG. 9 is a flowchart illustrating an example of a display control processing executed by the control unit 33 of the management server MS.

### DETAILED DESCRIPTION

Hereinbelow, one or more embodiments of the present invention will be described with reference to the drawings. Incidentally, the following embodiment is an embodiment in a case where the present invention is applied to a remote monitoring system capable of remotely monitoring drones. Incidentally, in the above embodiment, the drone has been described as an example of the unmanned aerial vehicle, but the present invention is also applicable to a flying robot and the like as examples of the unmanned aerial vehicle.

### 1. Configuration and Operation outline of Remote Monitoring System S

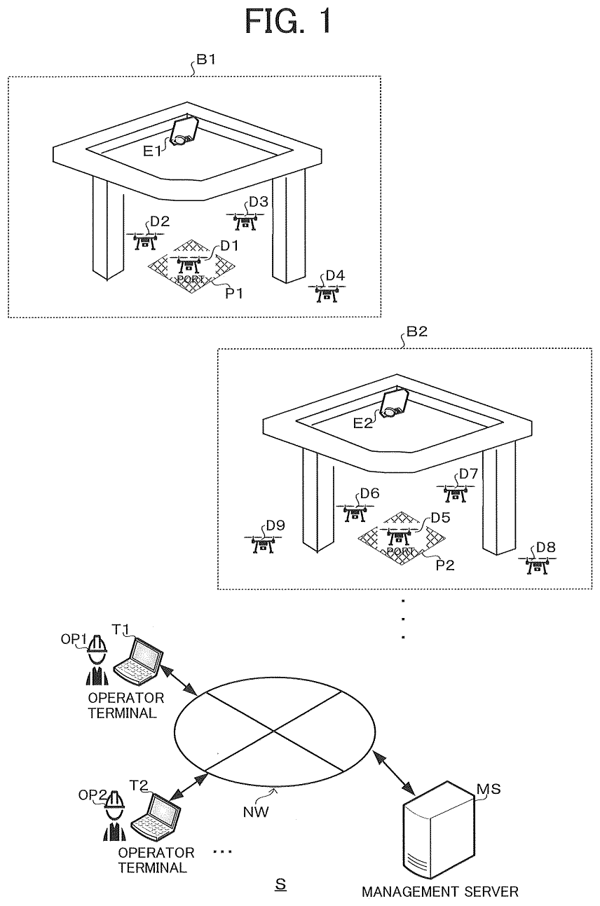

First, a description will be given as to a configuration and an operation outline of a remote monitoring system S according to the present embodiment with reference to FIG. 1. FIG. 1 is a diagram illustrating a: schematic configuration example of the remote monitoring system S. As illustrated in FIG. 1, the remote monitoring system S includes a plurality of drones Dn (n=1, 2, 3, . . . ), a plurality of operator terminals Tm (m=1, 2, . . . ), and a management server MS (an example of an information processing device and a predetermined server). The drone Dn, the operator terminal Tm, and the management server MS are each connected to a communication network NW. The communication network NW includes, for example, the Internet, a mobile communication network, a radio base station thereof, and the like.

The drone Dn is an example of an unmanned flying object, and is also referred to as a multicopter, or an UAV (Unmanned Aerial Vehicle). The drone Dn is capable of taking off according to takeoff instructions from a GCS (Ground Control Station) and flying autonomously. The drone Dn is used for, for example, delivery, surveying, photographing, monitoring, and the like. The GCS is installed as an application in the operator terminal Tm, for example, and is configured to be cooperated with the management server MS. Incidentally, the drone Dn can also fly according to remote control from the ground by a manipulator terminal (installing the GCS) used by a manipulator.

The drone Dn is under the control (in other words, jurisdiction) of any one of a plurality of drone bases Bm (in other words, the drone Dn belongs to any drone bases Bm). The drone base Bm is a base (e.g., a facility) where the drone Dn is allowed to take off or land. In the example of FIG. 1, each of the drones D1 to D4 is under the control of the drone base B1, departs (takes off) from the drone base B1, and returns (lands) to the drone base B1. Moreover, each of the drones D5 to D9 is under the control of the drone base B2, departs from the drone base B2, and returns to the drone base B2. However, one drone Dn may be under the control of the plurality of the drone bases Bm. For example, the drone D11 (not shown) may depart from the drone base B2 and return to the drone base B1. Incidentally, the number of drones Dn under the control of one drone base Bm is not particularly limited.

Moreover, in the drone base Bm, a port Pm used for takeoff and landing of drone Dn and a base instrument Em used for monitoring drone Dn are installed. At the drone base Bm, a base staff manually performs a pre-flight inspection (e.g., checking vehicle state or condition) of the drone Dn (hereinafter, the inspection is referred to as “manual inspection”). For example, the base staff visually inspects a predetermined portion of the drone Dn for each inspection item of the manual inspection, or inspects the predetermined portion of the drone Dn by touching it. Then, manual inspection result information indicating the result of the manual inspection by the base staff is transmitted to the management server MS via the communication network NW from a terminal such as a smartphone of the base staff. Moreover, the drone Dn, which has completed the pre-flight inspection, is placed at the port Pm and takes off (departs) from the port Pm according to a predetermined drone schedule. Moreover, the drone Dn that has returned to the drone base Bm lands at the port Pm. Incidentally, a plurality of ports Pm may be installed at one drone base Bm.

The base instrument Em is connected to the communication network NW, is equipped with a base camera (e.g., an RGB camera or an infrared camera) for monitoring the drone Dn. The base instrument Em stores a base ID (identification information) for identifying the drone base Bm. The base camera is configured to sequentially (continuously) capture (image) drone Dn placed, for example, at the port Pm. Base image information representing images (e.g., still images or moving images) captured by the base camera is transmitted from the base instrument Em to the management server MS together with the base ID. Incidentally, a plurality of the base instruments Em may be installed at one drone base Bm. Moreover, the base instrument Em may be provided with a wind sensor that detects (measures) at least one of wind speed and wind direction. Measurement information measured by the wind sensor is transmitted from the base instrument Em to the management server MS. Furthermore, the base instrument Em may be provided with at least one of a temperature sensor, a humidity sensor, a rainfall (snow) amount sensor, and an air pressure sensor (aerotonometer). Measurement information measured by these sensors is transmitted from the base instrument Em to the management server MS.

The operator terminal Tm is a terminal used by an operator OPm who remotely monitors the plurality of the drones Dn. The operator terminal Tm displays a first list (hereinafter referred to as the “drone list”) including drone simple (in other word, summary) information (an example of information on the drone Dn) on each of the plurality of the drones Dn that requires monitoring by the operator OPm. The operator OPm can monitor the drone Dn selected from the drone list while looking at information displayed on a screen (a user interface screen) of the operator terminal Tm. Such monitoring includes, for example, at least one of (i) checking the status of the pre-flight inspection of the drone Dn, (ii) monitoring the condition of the drone Dn before flight, (iii) monitoring the condition of the drone Dn in flight. Moreover, the monitoring may include actions that involve monitoring (e.g., instructions of the operator OPm). Incidentally, the management server MS is composed of one or a plurality of server computers that manages information on the drone base Bm for each drone base Bm. Moreover, the management server MS regularly or irregularly receives detailed weather information at the drone base Bm from a weather management server (not shown) via the communication network NW. The detailed weather information indicates the details of the weather.

### 1-1. Configuration and Function of Drone Dn

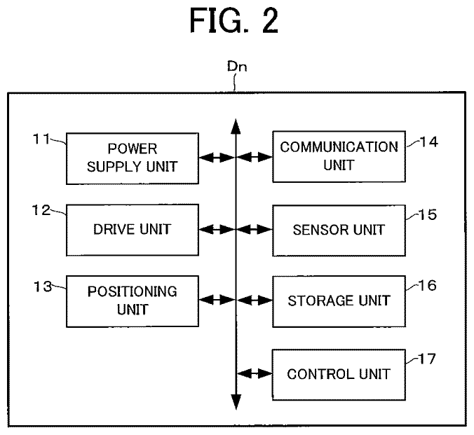

Next, a configuration and a function of the drone Dn will be described with reference to FIG. 2. FIG. 2 is a diagram illustrating a schematic configuration example of the drone Dn. As illustrated in FIG. 2, the drone Dn includes a power supply unit 11, a drive unit 12, a positioning unit 13, a communication unit 14, a sensor unit 15, a storage unit 16, a control unit 17, and the like. Furthermore, the drone Dn includes a propeller (a rotor), which is a horizontal rotary wing, an arm pipe (including an arm joint) for attaching the propeller to a drone main body (a housing), and the like. Incidentally, in a case where the drone Dn is used for delivery of an article, the drone Dn includes a holding mechanism or the like for holding the article.

The power supply unit 11 includes a detachable battery (an electric storage device) and the like. The power supply unit 11 supplies (supplies electricity) power stored in the battery to each unit of the drone Dn. Moreover, the power supply unit 11 sequentially measures a remaining battery capacity. Battery information indicating the remaining battery capacity measured by the power supply unit 11 is output to the control unit 17. The drive unit 12 includes a motor, a rotation shaft, and the like. The drive unit 12 rotates the plurality of rotors by a motor, a rotation shaft, and the like that are driven in accordance with a control signal output from the control unit 17.

The positioning unit 13 includes a radio wave receiver, an altitude sensor, and the like. The positioning unit 13 receives, for example, a radio wave transmitted from positioning satellites of a GNSS (Global Navigation Satellite System) such as a GPS (Global Positioning System) by a radio wave receiver, and sequentially detects, on the basis of the radio wave, a current position of the drone Dn. The current position of the drone Dn may be expressed by the latitude and longitude of the drone Dn, or by the latitude, longitude, and altitude of the drone Dn. Here, the positioning satellites may include satellites used by a plurality of satellite positioning systems, such as GPS (Global Positioning System) satellites, Michibiki (QZSS: Quasi-Zenith Satellite System) satellites, and Galileo satellites. Position information indicating the current position detected by the positioning unit 13 is sequentially output to the control unit 17. At this time, capture number information indicating the capture number (satellite capture number) of positioning satellites captured by the positioning unit 13 is sequentially output to the control unit 17. Incidentally, the positioning unit 13 may detect the altitude of the drone Dn by the altitude sensor. In this case, the position information indicating the current position of the drone Dn includes altitude information indicating the altitude detected by the altitude sensor. The communication unit 14 has an antenna and a wireless communication function, and is responsible for controlling communication performed via the communication network NW.

The sensor unit 15 includes various sensors used to control the drone Dn. Examples of the various sensors include a compass (a geomagnetic sensor), a gyro (a triaxial angular speed sensor), a triaxial acceleration sensor, an atmospheric pressure sensor, a gimbal, an optical sensor, a range finder (a distance meter), and the like. The optical sensor includes a vehicle (aircraft) camera (for example, an RGB camera and an IR (Infrared ray) camera) and the like. The vehicle camera is configured, for example, to sequentially capture images of the surroundings of the drone Dn (for example, in front of or below the drone Dn). Incidentally, the direction of the vehicle camera (e.g., forward or downward of the drone Dn) can be controlled by the control unit 17. Sensing information sensed by the sensor unit 15 is output to the control unit 17. The storage unit 16 includes a nonvolatile memory or the like, and stores various programs and data. Moreover, the storage unit 16 stores a vehicle ID (identification information) for identifying the drone Dn.

The control unit 17 includes at least one CPU (Central Processing Unit), an ROM (Read Only Memory), an RAM (Random Access Memory), and the like, and controls the drone Dn on the basis of the position information from the positioning unit 13 and the sensing information from the sensor unit 15. Such control includes control of a rotation speed of a propeller, control of a position, a posture, and a traveling direction of the drone Dn, and the like. The position information (i.e., the position information from the positioning unit 13) of the drone Dn, vehicle image information representing images (still images or moving images (video)) captured by the vehicle camera, the battery information from the power supply unit 11, and the capture number information from the positioning unit 13 are transmitted to the management server MS via the communication network NW together with the vehicle ID of the drone Dn.

Moreover, the control unit 17 has a self-diagnosis function and a fail-safe function, and performs an automatic inspection for each inspection item on whether a predetermined portion (for example, the power supply unit 11, the drive unit 12, the positioning unit 13, the communication unit 14, the sensor unit 15, or the like) of the drone Dn normally operates. The inspection items of the automatic inspection include, for example, the remaining battery capacity, the motor, the compass, the gyro, the acceleration sensor, the air pressure sensor (atmospheric pressure sensor), the gimbal, the optical sensor, the range finder, and the like. Automatic inspection result information indicating results of the automatic inspection by the drone Dn (that is, the control unit 17) is transmitted to the management server MS via the communication network NW. Incidentally, the automatic inspection by the drone Dn is performed before or during the drone Dn flies.

### 1-2. Configuration and Function of Operator Terminal Tm

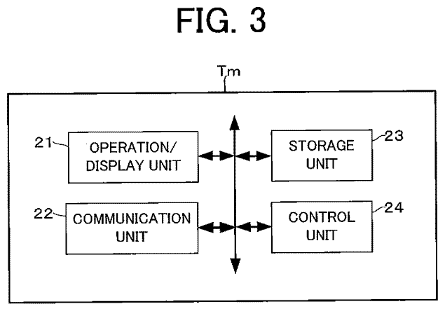

Next, a configuration and a function of the operator terminal Tm will be described with reference to FIG. 3. FIG. 3 is a diagram illustrating a schematic configuration example of the operator terminal Tm. The operator terminal Tm includes an operation/display unit 21, a communication unit 22, a storage unit 23, a control unit 24, and the like. As the operator terminal Tm, for example, a personal computer can be applied. The operator terminal Tm may include a voice processing unit and a speaker. The operation/display unit 21 has, for example, an input function for accepting input (selection) by a finger, pen, or mouse of the operator OPm, and a display function for displaying various screens on a display. The operation information indicating an instruction input from the operation/display unit 21 by the operator OPm is transmitted to the management server MS. The operator terminal Tm may be provided with a plurality of displays. The various screens include a login screen for the operator OPm to log in, a drone monitoring screen for the operator OPm to remotely monitor the drone Dn, and an action request notification screen for notifying the operator OPm of a request for a predetermined action. Incidentally, it is preferable that the drone monitoring screen and the action request notification screen are displayed on separate displays at the same time.

The communication unit 22 controls communication performed via the communication network NW. The storage unit 23 includes a non-volatile memory or the like, and stores various programs (program code groups) and pieces of data. The various programs include an operating system (OS), a monitoring application, the GCS, and a web browser. The monitoring application is mainly a program for acquiring, from the management server MS, information regarding the plurality of the drones Dn for which the operator OPm is in charge, and displaying the acquired information. Incidentally, the monitoring application may be downloaded from a predetermined server to the operator terminal Tm.

The control unit 24 (an example of a computer) includes at least one CPU, a ROM, an RAM, and the like, and executes processing in accordance with the monitoring application stored in the ROM (or, the storage unit 23). When the monitoring application is activated in response to an instruction of the operator OPm, the control unit 24 displays the login screen on the display. Then, when a user ID and a password are input by the operator OPm through the login screen, the control unit 24 transmits a login request including the user ID and the password to the management server MS via the communication unit 22 and the communication network NW. The user ID is identification information for identifying the operator OPm.

Then, when a login process is performed by the management server MS in response to the login request and the operator OPm logs in, display control data for displaying the drone list is transmitted from the management server MS, wherein the drone list indicates the plurality of the drones Dn for which the logged-in operator OPm is in charge. Thereby, the control 4 displays the drone monitoring screen including the drone list on the display. Incidentally, in the login processing, it is determined whether a set of the user ID and the password included in the login request is registered in a database. Then, when the set of the user ID and the password is registered, the operator OPm who uses the operator terminal Tm that has transmitted the login request is identified (identified by the user ID), and the operator OPm logs in.

Here, the plurality of the drones Dn indicated in the drone list may be under the control of the same drone base Bm, or may be under the control of different drone bases Bm. In the latter case, the drone list indicates the drones Dn belonging to each of the plurality of the drone bases Bm (e.g., the drone base B1 and drone base B2). This allows the operator OPm to remotely monitor each drone Dn under the control of the plurality of the drone bases Bm for which the operator OPm is in charge. Incidentally, the display control data may be data of a web page displayed by the web browser. The display control data of the drone monitoring screen may be incorporated into the monitoring application.

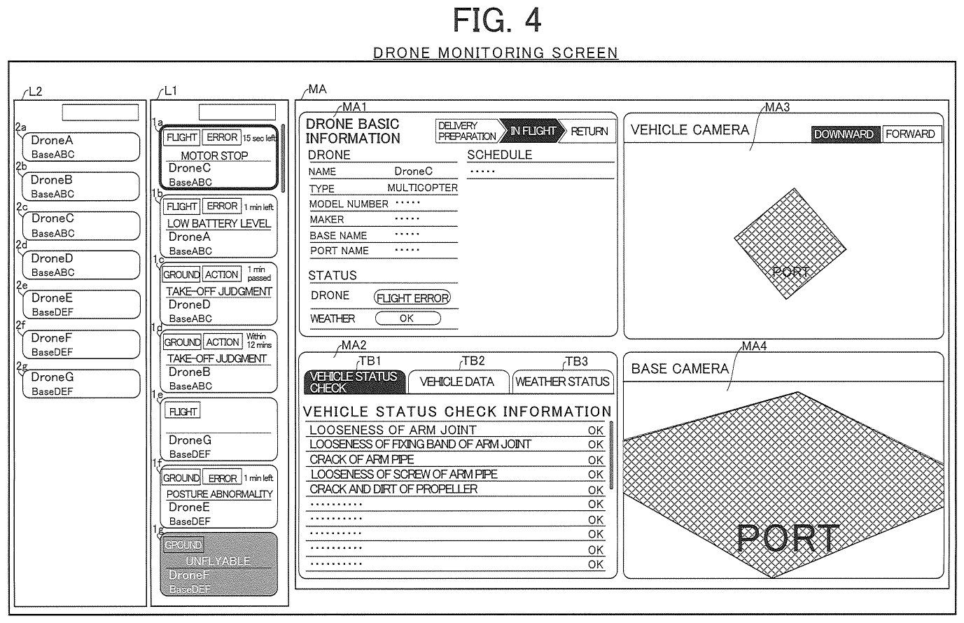

FIG. 4 is a diagram illustrating a display example of the drone monitoring screen displayed on the operator terminal T1 of the operator OP1. As illustrated in FIG. 4, the drone monitoring screen displays (e.g., displays side by side) drone lists L1, L2 including the drone simple information (i.e., drone simplified information) of each of the plurality of drones Dn (D1 to D7) that require monitoring by the operator OP1. The plurality of the drones Dn shown in the drone list L1 and the plurality of the drones Dn shown in the drone list L2 are basically identical. The display order (in other words, sorting order) of each drone simple information (in the example of FIG. 4, the display order of the drone simple information display areas 1a to 1g where each drone simple information is displayed) in the drone list L1 is controlled (e.g., changes in real time) according to a priority (hereinafter referred to as “monitoring priority”) for monitoring each drone Dn. As a result, the display order of each drone simple information changes in real time. Here, the monitoring priority indicates, for example, the priority of having the operator OP1 monitor. The monitoring priority is identified based on a status (hereinafter referred to as “drone status”) of the drone Dn. The monitoring priority can change as the drone status changes.

On the other hand, the display order of each drone simple information (in the example of FIG. 4, the display order of the drone simple information display areas 2a to 2g where each drone simple information is displayed) in the drone list L2 is not controlled according to the monitoring priority. Each drone simple information in the drone list L2 is displayed in an order based on, for example, a drone name (i.e., a name of the drone Dn) or a drone type (e.g., in syllabary order or alphabetical order), and basically the display order is fixed. In other words, the display order of each drone simple information in the drone list L2 does not frequently reorder (fluctuate) compared to the drone list L1. In the example of FIG. 4, the drone names of the drones D1 to D7 are respectively represented by “Drones A to G”. Incidentally, in the drone list L2, a display area for displaying the drone simple information of each of the drones D1, D3, and D7 in flight, a display area for displaying the drone simple information of each of the drones D2, D4, and D5 on the ground (that is, during landing), and a display area for displaying the drone simple information of the drone D6 that is unflyable may be provided separately.

In the drone list L1, the drone simple information display areas 1a to 1f are selectable by the operator OP1. In other words, any one of the drones D1 to D4 can be selected via any one of the drone simple information display areas 1a to 1f. In the example of FIG. 4, since the drone D3 is in the selected state by selecting (pressing) the drone simple information display area la by the operator OP1, the monitoring information (i.e., the monitoring information for the drone D3) to be used for monitoring the drone D3 in the selected state is displayed in the drone monitoring information display area MA. Here, the monitoring information includes, for example, the manual inspection result information, vehicle data information, the vehicle image information, the base image information, the measurement information, the detailed weather information, and the like. In the example of FIG. 4, the detailed weather information indicates the details of the weather at the drone base B1 where the drone D3 is under the control. The drone monitoring information display area MA includes a drone basic information display area MA1, a drone detailed information display area MA2, a vehicle camera display area MA3, and a base camera display area MA4. Incidentally, the drone simple information display area 1g positioned at the bottom of the drone list L1, is grayed out, but can be selected by the operator OP1. In this case, when the drone simple information display area 1g is selected by the operator OP1, the reason why the drone D6 is unflyable is displayed on the drone monitoring screen. This allows the operator OP1 to confirm the reason why the drone D6 cannot fly.

In the drone list L1, the drone simple information includes the drone name (or vehicle ID) of the drone Dn, the base name of the drone base Bm where the drone Dn is under the control, the drone status of the drone Dn, and drone status details. Here, the drone simple information should include at least the drone name (or vehicle ID) of the drone Dn, and preferably the drone status. Incidentally, the drone simple information may include a port name of the port Pm on which the drone Dn is landing. Whereas, in the drone list L2, the drone simple information includes the drone name (or vehicle ID) of the drone Dn, and the base name of the drone base Bm where the drone Dn is under the control, but does not include the drone status and drone status details of the drone Dn. That is, the display content of the drone list L2 is simplified compared to the display content of the drone list L1.

Moreover, in the drone list L1, the drone simple information displayed in the drone simple information display area 1a includes “FLIGHT ERROR” as the drone status of the drone D3 (drone name: “Drone C”) and “MOTOR STOP” as the drone status details (i.e., details of the flight error) of the drone D3. Here, “FLIGHT ERROR” indicates that some error (abnormality) is occurring with the drone D3 during flight (in flight), and the details of such error is “MOTOR STOP”. Moreover, the drone simple information displayed in the drone simple information display area 1b positioned below the drone simple information display area 1a includes “FLIGHT ERROR” as the drone status of the drone D1 (drone name: “Drone A”) and “LOW BATTERY LEVEL” as the drone status details of the drone D1. Incidentally, as the drone status of the drone D3 during flight, in addition to “FLIGHT ERROR”, there is also “FLIGHT ACTION”, although it is not shown in FIG. “FLIGHT ACTION” indicates that some action (e.g., landing permission instruction, or dropping permission instruction) by the operator OP1 is required for the drone D3 during flight.

Moreover, the drone simple information displayed in the drone simple information display area 1c positioned below the drone simple information display area 1b includes “GROUND ACTION” as the drone status of the drone D4 (drone name: “Drone D”) and “TAKE-OFF JUDGMENT” as the drone status details (i.e., details of the ground action) of the drone D4. Here, “GROUND ACTION” indicates that some action (e.g., take-off permission instruction) by the operator OP1 is necessary for the drone D4 located on the ground (e.g., placed on the port P1), and the details of such action are “TAKE-OFF JUDGMENT”. Incidentally, the action corresponding to the take-off judgment involves pressing the take-off judgment button, although it is not shown in FIG. Similarly, the drone simple information displayed in the drone simple information display area 1d positioned below the drone simple information display area 1c includes “GROUND ACTION” as the drone status of the drone D2 (drone name: “Drone B”) and “TAKE-OFF JUDGMENT” as the drone status details of the drone D2.

Moreover, the drone simple information displayed in the drone simple information display area le positioned below the drone simple information display area 1d includes “FLIGHT” as the drone status of the drone D7 (drone name: “Drone G”). Here, “FLIGHT” indicates that no error occurs with the drone D7 during flight. Moreover, the drone simple information displayed in the drone simple information display area 1f positioned below the drone simple information display area 1e includes “GROUND ERROR” as the drone status of the drone D5 name: “Drone E”) and “POSTURE ABNORMALITY” as the drone status details of the drone D5. Here, “GROUND ERROR” indicates that some error is occurring with the drone D5 on the ground, and the details of such error is “POSTURE ABNORMALITY”.

Moreover, the drone simple information displayed in the drone simple information display area 1g positioned at the bottom of the drone list L1 includes “UNFLYABLE” as the drone status of the drone D6 (drone name: “Drone F”). Here, “UNFLYABLE” indicates that the drone D6 on the ground cannot fly because the results (inspection results) of the pre-flight inspection (e.g., checking vehicle state or condition by the base staff) are not good. Therefore, the drone simple information display area 1g is grayed out. Incidentally, in the drone list L1, since the number of drone simple information display areas that can fit within the drone monitoring screen is limited, the drone simple information display area that cannot fit within one screen can be displayed by scrolling in response to an operation by the operator OP1.

Moreover, the basic information of the drone D3, the drone status of the drone D3, the drone schedule of the drone D3, and the weather status of the drone base B1 are displayed in the drone basic information display area MA1. Here, the basic information of the drone D3 includes, for example, the drone name, the drone type (e.g., type or model number), the maker (manufacturer), and the base name of the drone base B1. The drone schedule of the drone D3 includes, for example, a scheduled time of at least one of arrival at base, take-off, and arrival at destination (e.g., destination where a package is delivered). The weather status is based on the detailed weather information. Incidentally, the drone basic information display area MA1 may display the measurement information measured by the sensor provided by the base instrument Em.

In the display example of FIG. 4, a vehicle status check tab TB1, a vehicle data tab TB2, and a weather status tab TB3 are provided in the drone detailed information display area MA2. In this example, the vehicle status check tab TB1 is selected, and therefore the vehicle status check information is displayed below the tabs TB1 to TB3. The vehicle status check information is based on the manual inspection result information described above. Moreover, in the display example of FIG. 4, “OK” as displayed in association with the inspection item “LOOSENESS OF ARM JOINT”. which is included in the vehicle status check information, indicates for example, that the result of the pre-flight inspection is fine (good). Incidentally, when the vehicle data tab TB2 is selected, the vehicle data information is displayed at the bottom of tabs TB1 to TB3. The vehicle data information is based on the battery information and the capture number information, etc. described above. Moreover, if the weather status tab TB3 is selected, the detailed weather information of drone base B1 is displayed at the bottom of tabs TB1-TB3.

In the display example of FIG. 4, the moving image (i.e., vehicle camera video based on the vehicle image information) captured by the vehicle camera of the drone D1 is displayed in the vehicle camera display area MA3. On the other hand, the moving image (i.e., base camera video based on the base image information) captured by the base camera of the base instrument E1 is displayed in the base camera display area A4.

### 1-3. Configuration and Function of Management Server MS

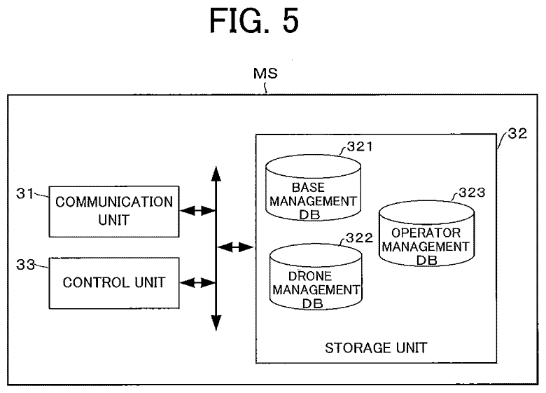

Next, a configuration and a function of the management server MS will be described with reference to FIG. 5. FIG. 5 is a diagram illustrating a schematic configuration example of the management server MS. As illustrated in FIG. 5, the management server MS includes a communication unit 31, a storage unit 32, a control unit 33, and the like. The communication unit 31 controls communication performed via the communication network NW. The manual inspection result information, the base image information, the measurement information, and the base ID of the drone base Bm, all of which are transmitted from the base instrument Em, are received by the communication unit 31. The battery information, the capture number information, the vehicle image information, the position information of the drone Dn, the automatic inspection result information, and the vehicle ID of the drone Dn, all of which are transmitted from drone Dn, are received by the communication unit 31. The management server MS can recognize the current position of the drone Dn based on the position information of the drone Dn. Moreover, the operation information and the login request, all of which are transmitted from the operator terminal Tm, are received by the communication unit 31. Moreover, the detailed weather information transmitted from the weather management server is received by the communication unit 31.

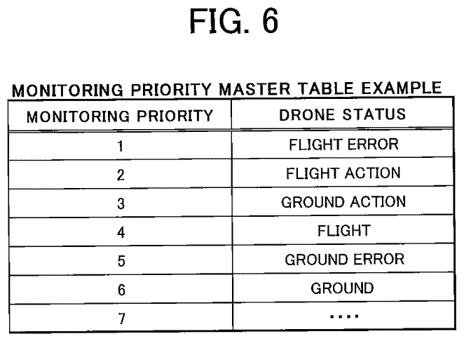

The storage unit 32 includes, for example, a hard disk drive or the like, and stores an operating system, various programs including an application, and the like. Here, the application includes a program for executing a display control method. The program may be stored in a non-transitory computer readable memory. Moreover, the storage unit 32 stores a monitoring priority master table. The monitoring priority master table is a table that registers a monitoring priority for each drone status. That is, the monitoring priority master table registers sets of the monitoring priority and the drone status. FIG. 6 is a diagram illustrating an example of the monitoring priority master table. In the example of FIG. 6, the monitoring priority “1” (Highest monitoring priority) is associated with “FLIGHT ERROR”, the monitoring priority “2” (Second highest monitoring priority) is associated with “FLIGHT ACTION”, and the monitoring priority “3” (Third highest monitoring priority) is associated with “GROUND ACTION”.

Here, “FLIGHT ERROR”, may be classified into multiple (various) types according to the degree (extent) of the error. The degree of the error may indicate an importance. In a case where there are a plurality of drones Dn whose the drone status indicates the flight error, it is possible to differentiate the respective monitoring priorities. Examples of the degree of the error include most important (the degree of the error is highest) and minor. For example, if the situation of the drone Dn is unknown, or if the drone Dn cannot take a safe landing means, the degree of the error is determined as the most important. Examples of cases where the drone Dn cannot take the safe landing means include when an automatic return (RtH) function of the drone Dn does not operate or when the drone Dn cannot land at an emergency landing point (ELZ). That is, in a case where there is a risk of an emergency landing on the drone Dn, or the drone Dn can only choose to land on the spot, the degree of the error is determined to be the most important. On the other hand, in a case where the drone Dn can maintain a safe state by the fail-safe function, or the drone Dn can take the safe landing means by the intervention of the operator OPm, etc., the degree of the error is determined to be minor.

Incidentally, it is preferable that the degree of the error is associated with the drone status and registered in the monitoring priority master table. In the example of FIG. 6, the degree of the error is categorized into two types: the most important and minor, but may be categorized into three or more types. Moreover, not only the flight error but also the ground error may be registered in association with the degree of the error. Moreover, in the example of FIG. 6, different monitoring priorities may be associated with different drone statuses (e.g., monitoring priority “3” for “GROUND ACTION” and monitoring priority “4” for “FLIGHT”) but the same monitoring priority may be associated with different drone statuses (e.g., monitoring priority “3” for “GROUND ACTION” and “FLIGHT”, respectively).

Furthermore, a base management database (DB) 321, a drone management database (DB) 322, and an operator management database (DB) 323 are constructed in the storage unit 32. The base management database 321 is a database for managing information on the drone base Bm. In the base management database 321, for example, the base ID of the drone base Bm, the base image information, the measurement information, the detailed weather information, the weather status, the vehicle ID of the drone Dn under the control of the drone base Bm, and the like are stored in association with each drone base Bm. Incidentally, the base image information, the measurement information, and the detailed weather information may be appropriately updated each time they are received by the communication unit 31.

The drone management database 322 is a database for managing information on the drone Dn. In the drone management database 322, the vehicle ID (drone ID), the position information, the basic information, the drone status, the drone schedule, the manual inspection result information, the vehicle data information, the vehicle image information, and the like are stored in association with each drone Dn. The vehicle data information includes, for example, the battery information, the capture number information, and the like. Incidentally, the manual inspection result information, the vehicle data information, the vehicle image information may be appropriately updated each time they are received by the communication unit 31.

Moreover, the drone status is updated appropriately based on, for example, various information (including information from the drone Dn) received by the communication unit 31, the drone schedule, or instruction information from a manager (administrator), etc. Moreover, a switching time when the drone status has been switched (i.e., changed) may be registered in the drone management database 322. Here, examples of the drone status being switched include when it is switched from “GROUND ACTION” to “FLIGHT”, or when it is switched from “FLIGHT” to “FLIGHT ERROR”. Incidentally, it is preferable that the switching time registered in the drone management database 322 is the most recent switching time. In this case, the switching time is overwritten and updated every time the drone status is switched.

The operator management database 323 is a database for managing information on the operator OPm. In the operator management database 323, the user ID of the operator OPm, the password of the operator OPm, a login status, the vehicle ID of each of the plurality of the drones Dn for which the operator OPm is in charge, a name of the operator OPm, and the like are stored in association with each operator OPm. Here, the login status indicates whether the operator OPm logs in.

The control unit 33 (an example of a computer) includes at least one CPU, a ROM, an RAM, and the like, and performs various processes according to the programs (program code) stored in the ROM, the storage unit 32, or the non-transitory computer readable memory. The CPU (an example of processor) is configured to access the program code stored in the ROM, the storage unit 32, or the non-transitory computer readable memory and operate as instructed by the program code. The program code includes: first display control code configured to cause the CPU to display, on the operator terminal Tm, a first drone list including information on each of a plurality of drones Dn that require monitoring by the operator OPm; first identification code configured to cause the CPU to identify a drone status of each of the plurality of the drones Dn; and second display control code configured to cause the CPU to control, based on the drone status of each of the plurality of the drones Dn, the display of the first drone list. Moreover, the program code may include second identification code configured to cause the CPU to identify, based on the drone status of each of the plurality of the drones Dn, a monitoring priority of each of the plurality of the drones Dn. Moreover, the program code may include: third display control code configured to cause the CPU to display, on the operator terminal Tm in response to a selection of any drone Dn by the operator OPm among the plurality of the drones Dn in the first drone list, monitoring information to be used for monitoring the selected drone Dn, and warning output control code configured to cause the CPU to output, from the operator terminal Tm, a warning message when the monitoring priority of the selected drone Dn is lower than the monitoring priority of the drone Dn whose handling for monitoring has not been completed among the plurality of the drones Dn in the first drone list. Moreover, the program code may include: third display control code configured to cause the CPU to display, on the operator terminal Tm in response to a selection of any drone Dn by the operator OPm among the plurality of the drones Dn in the first drone list, monitoring information to be used for monitoring the selected drone Dn; and warning output control code configured to cause the CPU to output, from the operator terminal Tm, a warning message when the monitoring priority of the selected drone Dn is not the highest among the plurality of drones Dn in the first drone list. Incidentally, the processor may be implemented using circuitry or processing circuitry which includes general purpose processors, special purpose processors, integrated circuits, ASICS, conventional circuitry and/or combinations thereof which are configured or programmed to perform the disclosed functionality. The processor may be hardware (or a combination of hardware and software) that carry out or are programmed to perform the recited functionality.

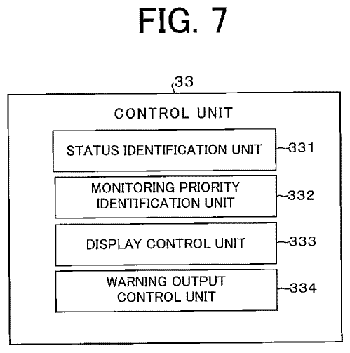

FIG. 7 is a diagram illustrating an example of functional blocks in the control unit 33. The control unit 33 functions a status identification unit 331, a monitoring priority identification unit 332, a display control unit 333, a warning output control unit 334 and the like as illustrated in FIG. 7, in accordance with the program (the program code) stored in the ROM, the storage unit 32, or the non-transitory computer readable memory.

The status identification unit 331 identifies the current drone status of each of the plurality of the drones Dn for which the logged-in operator OPm is in charge, for example, from the drone management database 322. The monitoring priority identification unit 332 identifies, based on each drone status identified by the status identification unit 331, the monitoring priority of each drone Dn. For example, the monitoring priority is identified for the display control of the drone list L1 shown in FIG. 4. This makes it possible for the operator OPm, who remotely monitors the plurality of the drones Dn, to quickly grasp (in other words, identify) the drone Dn that requires prioritized monitoring, while simplifying and speeding up the processing when the display control of the drone list L1 is performed. For example, the monitoring priority identification unit 332 may identify, from the monitoring priority master table, the monitoring priority associated with the drone status identified by the status identification unit 331. Incidentally, the monitoring priority identified for each drone Dn may be associated with the vehicle ID and recorded in a drone list table where the vehicle ID of each drone Dn is registered.

The display control unit 333 transmits, to the operator terminal Tm, display control data for displaying the drone lists L1 and L2 including the drone simple information of each of the plurality of the drones Dn for which the operator OPm is in charge. As a result, the drone list L1 and the drone list L2 are displayed on the drone monitoring screen of the operator terminal Tm, for example, as shown in FIG. 4. In this way, by displaying both the drone list L1 which is controlled (e.g., the display order is controlled) based on the drone status of the drone Dn, and the drone list L2 which is an order based on the drone name or the drone type, the ease of grasping the drone Dn that requires prioritized monitoring, can be improved. That is, even in a case where the operator's line of sight (user's gaze) moves frequently due to frequent changes of the order of the drone Dn in the drone list L1, the display control unit 333 causes the operator terminal Tm to display, alongside the drone list L1, the drone list L2 in which the order of the drone Dn basically does not change, in order to pursue the ease of grasping the drone Dn that requires prioritized monitoring.

Namely, the display control unit 333 controls the display of the drone list L1 according to the monitoring priority identified the monitoring by priority identification unit 332. For example, the display control unit 333 may control at least one of the display order and the a display mode (display manner) of the drone simple information in the drone list L1 according to the monitoring priority identified by the monitoring priority identification unit 332. This makes it possible for the operator OPm, who remotely monitors the plurality of the drones Dn, to quickly grasp at a glance the drone Dn that requires prioritized monitoring. Here, the display control unit 333 may update (e.g., change) at least one of the display order and the display mode of the drone simple information in the drone list L1 in response to switching of the drone status of any drone Dn. This makes it possible to efficiently update the display of the drone list L1. For example, in response to switching of the drone status, the display control data including the monitoring priority of each of the plurality of the drones Dn in the drone list L1 may be transmitted to the operator terminal Tm.

For example, in controlling the display order of the drone simple information, the display control unit 333 performs the display control so as to display the drone simple information of the drone Dn with a higher monitoring priority at an upper (higher) position (i.e., at a display position that is easier for the operator OPm to see) in the drone list L1. This makes it possible for the operator OPm to quickly grasp at a glance the drone Dn that requires prioritized monitoring. In a case where the drone statuses of the respective drones Dn are the same (e.g., the monitoring priorities are the same), the display control unit 333 causes the drone simple information of the drone Dn, whose switching of the drone status is the newest (i.e., the switching time is closest to the current time), among the plurality of the drones Dn to be displayed at an upper position in the drone list L1. This makes it possible for the operator OPm, who remotely monitors the plurality of the drones Dn, to quickly grasp the drone Dn that requires more prioritized monitoring. In other words, the monitoring priorities of the plurality of the drones Dn with the same drone status are adjusted.

Alternatively, in a case where the drone statuses of the respective drones Dn are the same (e.g., the monitoring priorities are the same) and the drone statuses indicate that an error (e.g., flight error) is occurring in the drones Dn, the display control unit 333 adjusts the monitoring priorities and causes the drone simple information of the drone Dn with the highest degree of the error (i.e., the degree of the error is the most important) to be displayed at an upper position in the drone list L1. This also makes it possible for the operator OPm, who remotely monitors the plurality of the drones Dn, to quickly grasp the drone Dn that requires more prioritized monitoring.

In the example of FIG. 4, since the drone statuses of the drone D4 and the drone D2 indicate the ground action, the same monitoring priority “3” is identified for the drone D4 and the drone D2. Therefore, the display control unit 333 identifies the most recent switching time of the respective drone statuses of the drone D4 and the drone D2, and adjusts the monitoring priorities such that the monitoring priority of the drone D4, whose switching of the drone status is the newest (i.e., the most recent switching time is closer to the current time) among the drone D4 and the drone D2, becomes higher. Accordingly, the display control unit 333 causes the drone simple information of the drone D4, whose switching of the drone status is the newest among the drone D4 and the drone D2, to be displayed at an upper position than the drone simple information of the drone D2. Incidentally, even when the drone statuses of the three or more drones Dn are the same, the display control unit 333 identifies the most recent switching time of the respective drone statuses, and adjusts the monitoring priorities such that the monitoring priority increases in order of the switching time (i.e., the closer the switching time is to the current time, the higher the monitoring priority).

Moreover, in the example of FIG. 4, since the drone status of the drone D3 and the drone D1 indicate a flight error, the same monitoring priority “1” is identified for the drone D3 and the drone D1. Therefore, the display control unit 333 determines, as the most important, the degree of the error of the drone D3 based on the drone status details (motor stop) of the drone D3, and determines, as minor, the degree of the error of the drone D1 based on the drone status details (low battery level) of the drone D1. Then, the display control unit 333 adjusts the monitoring priorities such that the monitoring priority of the drone D3 with the highest degree of the flight error among the drone D3 and the drone D1 becomes the highest. As a result, the display control unit 333 causes the drone simple information of the drone D3, in which the degree of the error is the most important, to be displayed at an upper position than the drone simple information of the drone D1 in which the degree of the error is minor.

Incidentally, in a case where the drone statuses of the respective drones Dn are the same and the drone statuses indicate that an error is occurring in the drones Dn, without determining the degree of the error, the display control unit 333 may cause the drone simple information of the drone Dn, whose switching of the drone status is the newest among the plurality of the drones Dn, to be displayed at an upper position in the drone list L1.

On the other hand, in controlling the display mode of the drone simple information, the display control unit 333 causes the drone simple information of the drone Dn with a higher monitoring priority with a conspicuous (prominent) display mode (i.e., display mode that attracts the attention of the operator OPm), to be displayed in the drone list L1. Here, examples of displaying in the conspicuous display mode include setting a size of characters, etc. representing the drone simple information to a larger size than standard setting (i.e., standard size), setting a color of characters, etc. representing the drone simple information to a brighter color (e.g., red) than standard setting (i.e., standard color), and setting a thickness of line of characters, etc. representing the drone simple information to a thicker line than standard setting (i.e., standard thickness). Here, the characters, etc. may be at least one of letters, symbols, patterns, and shapes. Incidentally, examples of displaying in the conspicuous display mode may include transitioning characters, etc. representing the drone simple information from a non-flashing state to a flashing state, setting a color of a region (background, or frame of the region) for displaying characters, etc. representing the drone simple information to a brighter color than standard setting (i.e., standard color), and setting a thickness of the frame of the region for displaying characters, etc. representing the drone simple information to a thicker frame than standard setting (i.e., standard thickness).

Incidentally, in a case where the drone statuses of the respective drones Dn are the same, the display control unit 333 may adjust the monitoring priorities and cause the drone simple information of the drone Dn, whose switching of the drone status is the newest among the plurality of the drones Dn, to be displayed with the conspicuous display mode. Alternatively, in a case where the drone statuses of the respective drones Dn are the same and the drone statuses indicate that an error (e.g., flight error) is occurring in the drones Dn, the display control unit 333 may adjust the monitoring priorities and cause the drone simple information of the drone Dn with the highest degree of the error, to be displayed with the conspicuous display mode.

Moreover, in response to a selection of any drone Dn by the operator OPm among the plurality of the drone Dn in the drone list L1, the display control unit 333 transmits, to the operator terminal Tm, display control data for displaying monitoring information for the selected drone Dn. Incidentally, selection information including the vehicle ID of the drone Dn selected by the operator OPm is transmitted from the operator terminal Tm to the management server MS. As a result, for example, in FIG. 4, the drone simple information display area la of the drone D3 selected in the drone list L1 becomes the selected, and monitoring information for the drone D3 is displayed in the drone monitoring information display area MA on the drone monitoring screen of the operator terminal T1.

For example, the operator OP1 can appropriately address (respond to) the flight error while looking at the monitoring information for the drone D3. As a result, when the drone status of the drone D3 switches from the flight error to the flight, the monitoring priority of the drone D3 is lowered. Therefore, the display control unit 333 transitions the drone simple information of the drone D3 from the top position to a lower position in the drone list L1, and also transitions the drone simple information of the other drone Dn (for example, drone D1) from a lower position to the top position.

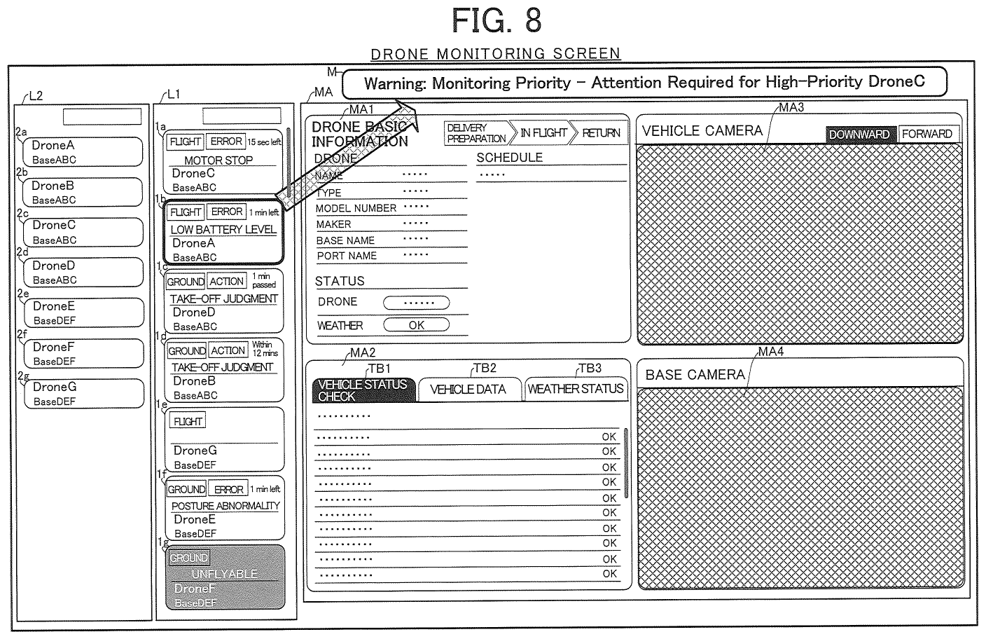

The warning output control unit 334 causes the operator terminal Tm to output a warning message when the monitoring priority of the drone Dn selected by the operator OPm in the drone list L1 is lower than the monitoring priority of the drone Dn not yet selected (i.e., the drone Dn whose handling for monitoring has not been completed) among the plurality of the drone Dn in the drone list L1. This makes it possible to accurately prevent delays in a response (e.g., an instruction of a predetermined action, etc.) by the operator OPm for the drone Dn not yet selected. Incidentally, the warning message may be displayed on the operator terminal Tm or may be audibly output from the operator terminal Tm. FIG. 8 is a diagram illustrating a display example of the drone monitoring screen displayed on the operator terminal T1 when the drone D1 with a lower monitoring priority than the drone D3, is first selected by the operator OP1. In the example of FIG. 8, the warning message M is displayed on the drone monitoring screen of the operator terminal T1 because the drone D1 with a lower monitoring priority than the drone D3, has been selected by the operator OP1, despite the fact that the response (e.g., an instruction of a predetermined action, etc.) by the operator OP1 for the drone D3 has not yet been completed (i.e., the handling for monitoring the drone Dn has not yet been completed).

Incidentally, a flag indicating that the drone Dn has been selected in the drone list L1 may be recorded in the drone list table in association with the vehicle ID and the monitoring priority of the selected drone Dn. Moreover, the warning output control unit 334 may determine, by referring to the drone list table described above, whether the drone Dn with a lower monitoring priority than the drone Dn that has not yet been selected, is selected first. However, the flag indicating that the drone Dn has been selected may not be recorded in association with the vehicle ID of the selected drone Dn. This is because the display order of the drone simple information is updated in response to the drone status of the drone Dn being switched. In this case, the warning output control unit 334 causes the operator terminal Tm to output the warning message when the monitoring priority of the drone Dn selected by the operator OPm is the highest (i.e., the selected drone Dn is not having the highest priority) among the plurality of the drone Dn in the drone list L1. This makes it possible to accurately prevent delays in the response by the operator OPm, while reducing a server load for recording the flag indicating that the drone Dn has been selected.

### 2. Operation of Remote Monitoring System S

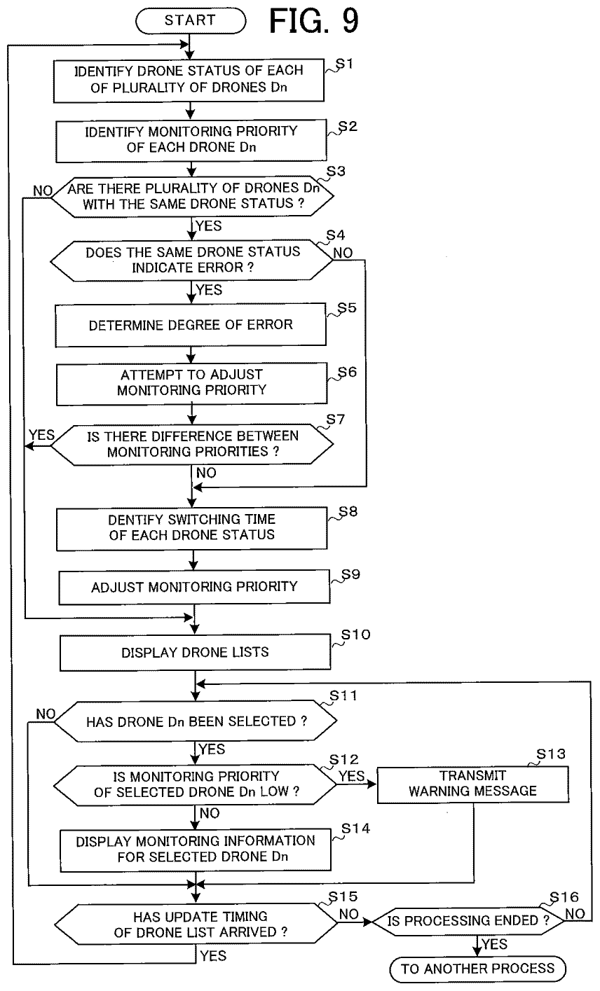

Next, an operation of the remote monitoring system S will be described with reference to FIG. 9. FIG. 9 is a flowchart illustrating an example of a display control processing executed by the control unit 33 of the management server MS. Incidentally, as a premise of the following description of the operation example, the operator OP1 of the operator terminal T1 is logged in, and the plurality of the drones Dn for which the logged-in operator OP1 is in charge are identified.

The processing illustrated in FIG. 9 is started, for example, when the drone monitoring screen is displayed on the operator terminal T1. When the processing illustrated in FIG. 9 is started, the control unit 33 identifies, by the status identification unit 331, the drone status of each of the plurality of the drones Dn for which the operator OP1 is in charge, for example, from the drone management database 322 (step S1). Incidentally, in subsequent processing, the status identification unit 331 may identify the drone status of each of the plurality of drones Dn for which the operator OP1 is in charge at a predetermined time interval.

Next, the control unit 33 identifies (e.g., acquires from the monitoring priority master table), by the monitoring priority identification unit 332, the monitoring priority of each drone Dn based on each drone status identified in step S1 and the monitoring priority master table (step S2). The monitoring priority identified in this way is associated with the vehicle ID of the corresponding drone Dn and stored in an adjustable (updatable) manner as described later.

Next, the control unit 33 determines whether there are the plurality of the drones Dn with the same drone status identified in step S1 (step S3). When it is determined that there are the plurality of the drones Dn with the same drone status (step S3: YES), the process proceeds to step S4. On the other hand, when it is determined that there are not the plurality of the drones Dn with the same drone status (step S3: NO), the process proceeds to step S10.

In step S4, the control unit 33 determines whether the same drone status indicates an error (e.g., a flight error). When it is determined that the same drone status indicates the error (step S4: YES), the process proceeds to step S5. On the other hand, when it is determined that the same drone status does not indicate the error (step S4: NO), the process proceeds to step S8.

In step S5, the control unit 33 determines the degree of the error of the same drone status, for example, by referring to the monitoring priority master table. Next, the control unit 33 attempts to adjust, based on the degree of the error determined in step S5, the monitoring priority of each of the drones Dn with the same drone status indicating the error (step S6). For example, if the monitoring priorities of the drone D3 and the drone D1 are “1”, the monitoring priority of the drone D3 is adjusted to “1-1” and the monitoring priority of the drone D1 is adjusted to “1-2”, thereby achieving adjustment between the drone D3 and the drone D1, both of which have the monitoring priority “1”.

Next, the control unit 33 determines whether there is a predetermined difference between the plurality of the monitoring priorities by adjusting in step S6 (step S7). When it is determined that there is no predetermined difference between the plurality of the monitoring priorities (step S7: NO), the process proceeds to step S8. Incidentally, in a case where there are three or more identical monitoring priorities, if there is no predetermined difference between all monitoring priorities, the process proceeds to step S8. On the other hand, when it is determined that there is the predetermined difference between the plurality of the monitoring priorities (step S7: YES), the process proceeds to step $10.

In step S8, the control unit 33 identifies the most recent switching time of the drone status (i.e., the same drone status) of each of the drones Dn. Next, the control unit 33 adjusts, based on the switching time identified in step S8, the respective monitoring priorities of the drones Dn with the same drone status (step S9). That is, the monitoring priorities are adjusted in ascending order of switching time (i.e., so that the newer the switching time, the higher the monitoring priority). Incidentally, if the most recent switch times of the respective drone statuses are the same, the monitoring priorities may be adjusted so as to differentiate the monitoring priorities in the order based on the drone name of the drone Dn.

In step S10, the control unit 33 transmits, to the operator terminal T1 by the display control unit 333, display control data for displaying the drone lists L1 and L2 indicating each drone Dn whose the monitoring priority has been identified (or adjusted) in the above process. As a result, the drone lists L1 and L2 are displayed on the drone monitoring screen. The display control data may include the drone simple information and the monitoring priority of each of the drones Dn. As a result, in the drone list L1 displayed on the operator terminal T1, the drone simple information of each drone Dn is displayed in the display order (or display mode) according to each monitoring priority. Moreover, in the drone list L2 displayed on the operator terminal T1, the drone simple information of each drone Dn is displayed in the order based on the drone name. Incidentally, the display control data may be data (e.g., web page data) in which the drone simple information of each drone Dn is arranged (layout) in a display order (or display mode) according to each monitoring priority. In this case, each monitoring priority may not be included in the display control data.

Next, the control unit 33 determines whether any drone Dn has been selected by the operator OP1 among the plurality of the drone Dn in the drone list L1 (step S11). For example, when the selection information including the vehicle ID of the drone Dn selected by the operator OP1 is received by the communication unit 31, it is determined that the drone Dn has been selected. When it is determined that the drone Dn has been selected (step S11: YES), the process proceeds to step S12. On the other hand, when it is determined that the drone Dn has not been selected (step S11: NO), the process proceeds to step S15.

In step S12, the control unit 33 determines whether the monitoring priority of the drone Dn selected by the operator OP1 is lower than the monitoring priority of the drone Dn whose handling for monitoring has not been completed among the plurality of the drone Dn in the drone list L1. When it is determined that the monitoring priority of the selected drone Dn is lower than the monitoring priority of the drone Dn whose handling for monitoring has not been completed (step S12: YES), the process proceeds to step S13. On the other hand, when it is determined that the monitoring priority of the selected drone Dn is not lower (i.e., higher) than the monitoring priority of the drone Dn whose handling for monitoring has not been completed (step S12: NO), the process proceeds to step S14. Incidentally, whether handling for monitoring the drone Dn has been completed may be determined by control unit 33 based on the operation information from the operator terminal T1.

Incidentally, in step S12, the control unit 33 may determine whether the monitoring priority of the drone Dn selected by the operator OP1 is the highest among the plurality of the drone Dn in the drone list L1. Then, when it is determined that the monitoring priority of the drone Dn selected by the operator OP1 is not the highest among the plurality of the drone Dn in the drone list L1 (step S12: YES), the process proceeds to step S13. On the other hand, when it is determined that the monitoring priority of the drone Dn selected by the operator OP1 is the highest among the plurality of the drone Dn in the drone list L1 (step S12: NO), the process proceeds to step S14.

In step S13, the control unit 33 transmits the warning message to the operator terminal T1 by the warning output control unit 334. Thereby, the warning message is output from the operator terminal T1. In step S14, the control unit 33 transmits, to the operator terminal T1, the display control data for displaying the monitoring information for the drone Dn selected by the operator OP1. As a result, the monitoring information for the drone Dn selected in the drone list L1 is displayed in the monitoring information display area MA.

In step S15, the control unit 33 determines whether a update timing of the drone list has arrived. It is preferable that the update timing is set by a timer to arrive at, for example, every predetermined time interval. When it is determined that the update timing of the drone list has arrived (step S15: YES), the process returns to step S1. As a result, the display of the drone list L1 and L2 is updated. Incidentally, when the drone status of any drone Dn among the plurality of the drone Dn for which the operator OP1 is in charge is switched, it may be determined that the update timing of the drone list has arrived.

On the other hand, when it is determined that the update timing of the drone list has not arrived (step S15: NO), the process proceeds to step S16. In step S16, the control unit 33 determines whether to end the display control processing. For example, when the control unit 33 receives a screen transition request from the operator terminal T1 in response to a transition instruction to another screen by the operator OP1, the control unit 33 determines that the display control processing is terminated (step S16: YES) and proceeds to another processing. On the other hand, it is determined that the display control processing is not terminated (step S16: NO), the process returns to step S11.

As described above, according to the above-described embodiment, the management server MS causes the operator terminal Tm to display the drone lists L1 including the drone simple information on each of the plurality of the drones Dn that requires monitoring by the operator OPm, and identifies the drone status of each of the plurality of the drones Dn. Then, the management server MS identifies, based on the identified drone statuses, the monitoring priority of each drone Dn, and controls the display of the drone list L1 according to the identified monitoring priorities. Therefore, it is possible for the operator OPm, who remotely monitors multiple drones Dn, to quickly identify the drone Dn that requires prioritized monitoring, thereby preventing delays in the operator OPm's response. In other words, it is possible for the operator OPm to quickly determine which of the multiple drones Dn under their supervision requires prioritized response.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above-described embodiment, by utilizing the monitoring priority identified based on the drone status of each drone Dn, it is possible to simplify and speed up the processing when controlling the display of the drone list L1. However, such monitoring priority may not be utilized, and the display of the drone list L1 may be controlled based on the drone status of each drone Dn. In this case, the management server MS may pre-store reference information that identifies in a brute-force manner (i.e., using a brute-force approach) which drone simple information corresponding to which drone status among multiple drone statuses should be displayed in a higher display order (or which drone simple information corresponding to which drone status should be displayed in a more conspicuous display mode). And then when the management server MS identifies each drone status of the drone Dn, it may control the display of the drone list L1 by referring to the reference information.

Moreover, in the above-described embodiment, the operator terminal Tm (the control unit 24), in accordance with the monitoring application, may acquire, from the management server MS, the drone lists L1 including the drone simple information on each of the plurality of the drones Dn that requires monitoring by the operator OPm, and display the acquired drone lists L1. Then, the operator terminal Tm (the control unit 24) may acquire, from the management server MS, the drone status of each of the plurality of the drones Dn, and identify, based on the acquired drone statuses, the monitoring priority of each drone Dn. Then, the operator terminal Tm (the control unit 24) may control the display of the drone list L1 according to the identified monitoring priorities. In this case, the monitoring priority master table described above may be stored in the storage unit 23 of the operator terminal Tm. Moreover, the operator terminal Tm may store the above reference information in advance in the same manner as the management server MS, and control the display of the drone list L1 by referring to the reference information when the respective drone statuses are acquired.

### Note

[1] An information processing device according to the present disclosure includes: a first display control unit configured to display, on a terminal of an operator, a first list including information on each of a plurality of unmanned aerial vehicles that require monitoring by the operator; a first identification unit configured to identify a status of each of the plurality of the unmanned aerial vehicles; and a second display control unit configured to control the display of the first list on the basis of the status of each of the plurality of the unmanned aerial vehicles. This makes it possible for the operator, who remotely monitors the plurality of unmanned aerial vehicles, to quickly grasp the unmanned aerial vehicle that requires prioritized monitoring.

[2] The information processing device described in [1] above, further includes a second identification unit configured to identify a monitoring priority of each of the plurality of the unmanned aerial vehicles on the basis of the status of each of the plurality of the unmanned aerial vehicles, wherein the second display control unit is configured to control the display of the first list according to the monitoring priority of each of the plurality of the unmanned aerial vehicles. This makes it possible for the operator, who remotely monitors the plurality of unmanned aerial vehicles, to quickly grasp the unmanned aerial vehicle that requires prioritized monitoring, while simplifying and speeding up the processing when controlling the display of the first list.

[3] In the information processing device described in [2] above, wherein the second display control unit is configured to control at least one of a display order and a display mode of information on each of the plurality of the unmanned aerial vehicles in the first list according to the monitoring priority of each of the plurality of the unmanned aerial vehicles. This makes it possible for the operator, who remotely monitors the plurality of unmanned aerial vehicles, to quickly grasp at a glance the unmanned aerial vehicle that requires prioritized monitoring.

[4] In the information processing device described in any one of [1] to [3] above, wherein the second display control unit is configured to update at least one of the display order and the display mode of information on each unmanned aerial vehicle in the first list, in response to switching of the status of any unmanned aerial vehicle. This makes it possible to efficiently update the display of the first list.

[5] In the information processing device described in any one of [2] to [4] above, wherein the second display control unit is configured to compare the monitoring priorities of the plurality of unmanned aerial vehicles, and to display the information on the unmanned aerial vehicle with higher monitoring priority at an upper position in the first list. This makes it possible for the operator, who remotely monitors the plurality of unmanned aerial vehicles, to quickly grasp at a glance the unmanned aerial vehicle that requires prioritized monitoring.

[6] The information processing device described in any one of [2] to [5] above, further includes: a third display control unit configured to display, on the terminal in response to a selection of any unmanned aerial vehicle by the operator among the plurality of the unmanned aerial vehicles in the first list, monitoring information to be used for monitoring the selected unmanned aerial vehicle; and a warning output control unit configured to cause the terminal to output a warning message when the monitoring priority of the selected unmanned aerial vehicle is lower than the monitoring priority of the unmanned aerial vehicle whose handling for monitoring has not been completed among the plurality of the unmanned aerial vehicles in the first list. This makes it possible to accurately prevent delays in a response by the operator.

[7] The information processing device described in any one of [2] to [5] above, further includes: a third display control unit configured to display, on the terminal in response to a selection of any unmanned aerial vehicle by the operator among the plurality of the unmanned aerial vehicles in the first list, monitoring information to be used for monitoring the selected unmanned aerial vehicle; and a warning output control unit configured to cause the terminal to output a warning message when the monitoring priority of the selected unmanned aerial vehicle is not the highest among the plurality of unmanned aerial vehicles in the first list. This makes it possible to accurately prevent delays in a response by the operator.

[8] In the information processing device described in any one of [1] to [7] above, wherein the first display control unit is configured to display, on the terminal, a second list in which a display order of information on each unmanned aerial vehicle is based on a name or type of each of the plurality of the unmanned aerial vehicles, in addition to the first list. Thus, by displaying both the first list controlled based on the status of the unmanned aerial vehicle and the second list in an order based on the name of the unmanned aerial vehicle, it is possible to improve ease of grasping the unmanned aerial vehicle that requires prioritized monitoring.

[9] In the information processing device described in any one of [1] to [8] above, wherein the second display control unit is configured to display, when the status of first unmanned aerial vehicle and the status of second unmanned aerial vehicle are the same, the information on the first or second unmanned aerial vehicle with a newer status switching at an upper position in the first list. This makes it possible for the operator, who remotely monitors the plurality of unmanned aerial vehicles, to quickly grasp the unmanned aerial vehicle that requires more prioritized monitoring.

[10] In the information processing device described in any one of [1] to [9] above, wherein the second display control unit is configured to display, when the status of first unmanned aerial vehicle and the status of second unmanned aerial vehicle are the same and the status indicates that an abnormality has occurred in the unmanned aerial vehicle, the information on the unmanned aerial vehicle with higher degree of the abnormality at an upper position in the first list. This makes it possible for the operator, who remotely monitors the plurality of unmanned aerial vehicles, to quickly grasp the unmanned aerial vehicle that requires more prioritized monitoring.

[11] A display control method executed by one or more computers, according to the present disclosure, includes: displaying, on a terminal of an operator, a first list including information on each of a plurality of unmanned aerial vehicles that require monitoring by the operator; identifying a status of each of the plurality of the unmanned aerial vehicles; and controlling the display of the first list based on the status of each of the plurality of the unmanned aerial vehicles.

A program according to the present disclosure, is configured to cause a computer to: display, on a terminal of an operator, a first list including information on each of a plurality of unmanned aerial vehicles that require monitoring by the operator; acquire a status of each of the plurality of the unmanned aerial vehicles acquire a status of each of the plurality of the unmanned aerial vehicles from a predetermined server; and control the display of the first list based on the status of each of the plurality of the unmanned aerial vehicles.

### Reference Signs List

11 Power supply unit

12 Drive unit

13 Positioning unit

14 Communication unit

15 Sensor unit

16 Storage unit

17 Control unit

21 Operation/display unit

22 Communication unit

23 Storage unit

24 Control unit

31 Communication unit

32 Storage unit

33 Control unit

331 Status identification unit

332 Monitoring priority identification unit

333 Display control unit

334 Warning output control unit

Dn Drone

Tm Operator terminal

MS Management server

S Remote monitoring system

What is claimed is:

1. An information processing device comprising:
at least one memory configured to store program code; and at least one processor configured to access the program code and operate as instructed by the program code, the program code including:
first display control code configured to cause the at least one processor to display, on a terminal of an operator, a first list including information on each of a plurality of unmanned aerial vehicles that require monitoring by the operator;
first identification code configured to cause the at least one processor to identify a status of each of the plurality of the unmanned aerial vehicles; and
second display control code configured to cause the at least one processor to control, based on the status of each of the plurality of the unmanned aerial vehicles, the display of the first list.

2. An information processing device according to claim 1, further comprising second identification code configured to cause the at least one processor to identify, based on the status of each of the plurality of the unmanned aerial vehicles, a monitoring priority of each of the plurality of the unmanned aerial vehicles,
wherein the second display control code is configured to cause the at least one processor to control the display of the first list according to the monitoring priority of each of the plurality of the unmanned aerial vehicles.

3. An information processing device according to claim 2, wherein the second display control code is configured to cause the at least one processor to control at least one of a display order and a display mode of information on each of the plurality of the unmanned aerial vehicles in the first list according to the monitoring priority of each of the plurality of the unmanned aerial vehicles.

4. An information processing device according to claim 3, wherein the second display control code is configured to cause the at least one processor to update at least one of the display order and the display mode of information on each unmanned aerial vehicle in the first list, in response to switching of the status of any unmanned aerial vehicle.

5. An information processing device according to claim 2, wherein the second display control code is configured to cause the at least one processor to compare the monitoring priorities of the plurality of unmanned aerial vehicles, and to display the information on the unmanned aerial vehicle with higher monitoring priority at an upper position in the first list.

6. An information processing device according to claim 2, further comprising: third display control code configured to cause the at least one processor to display, on the terminal in response to a selection of any unmanned aerial vehicle by the operator among the plurality of the unmanned aerial vehicles in the first list, monitoring information to be used for monitoring the selected unmanned aerial vehicle; and
warning output control code configured to cause the at least one processor to output, from the terminal, a warning message when the monitoring priority of the selected unmanned aerial vehicle is lower than the monitoring priority of the unmanned aerial vehicle whose handling for monitoring has not been completed among the plurality of the unmanned aerial vehicles in the first list.

7. An information processing device according to claim 2, further comprising: third display control code configured to cause the at least one processor to display, on the terminal in response to a selection of any unmanned aerial vehicle by the operator among the plurality of the unmanned aerial vehicles in the first list, monitoring information to be used for monitoring the selected unmanned aerial vehicle; and
warning output control code configured to cause the at least one processor to output, from the terminal, a warning message when the monitoring priority of the selected unmanned aerial vehicle is not the highest among the plurality of unmanned aerial vehicles in the first list.

8. An information processing device according to claim 1, wherein the first display control code is configured to cause the at least one processor to display, on the terminal, a second list in which a display order of information on each unmanned aerial vehicle is based on a name or type of each of the plurality of the unmanned aerial vehicles, in addition to the first list.

9. An information processing device according to claim 1, wherein the second display control code is configured to cause the at least one processor to display, when the status of first unmanned aerial vehicle and the status of second unmanned aerial vehicle are the same, the information on the first or second unmanned aerial vehicle with a newer status switching at an upper position in the first list.

10. An information processing device according to claim 1, wherein the second display control code is configured to cause the at least one processor to display, when the status of first unmanned aerial vehicle and the status of second unmanned aerial vehicle are the same and the status indicates that an abnormality has occurred in the unmanned aerial vehicle, the information on the unmanned aerial vehicle with higher degree of the abnormality at an upper position in the first list.

11. A display control method executed by one or more computers comprising:
displaying, on a terminal of an operator, a first list including information on each of a plurality of unmanned aerial vehicles that require monitoring by the operator;
identifying a status of each of the plurality of the unmanned aerial vehicles; and
controlling the display of the first list based on the status of each of the plurality of the unmanned aerial vehicles.

12. A non-transitory computer readable memory having stored thereon a program configured to cause a computer to:
display, on a terminal of an operator, a first list including information on each of a plurality of unmanned aerial vehicles that require monitoring by the operator;
acquire a status of each of the plurality of the unmanned aerial vehicles from a predetermined server; and
control the display of the first list based on the status of each of the plurality of the unmanned aerial vehicles.
